(19) United States
(12) Patent Application Publication
(10) Pub. No.: US 2005/0092762 A1
(43) Pub. Date: May 5, 2005

(54) Food cooking basket for pressure cooker pressure cooker for receiving cooking basket and method for making a cooking basket by swaging

(76) Inventors: Marie-Pierre Murat, Fontaine Les Dijon (FR); Ines Birlouez-Aragon, Paris (FR); Jean-Louis Lanoiselle, Salency (FR); Eric Christian Jacques Rhetat, Dijon (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/496,625

(22) PCT Filed: Nov. 27, 2002
(86) PCT No.: PCT/FR02/04070

(30) Foreign Application Priority Data
Nov. 27, 2001 (FR) 01/15577

(51) Int. Cl. A47J 36/00

(52) U.S. Cl. 220/912

(57) ABSTRACT

The present application provides a food-cooking basket for pressure cooking in a pressure cooker, the basket being made of a sheet of rigid material defining a bottom and side walls of the basket. The sheet is provided with perforations, which are provided at least through the side walls and represent at least 30% of the total area of the sheet. The invention is applicable to pressure cooking appliances.

### TECHNICAL FIELD

The present invention relates to the general technical field of appliances for pressure cooking, such as pressure cookers, and more particularly it relates to food-cooking baskets which are designed to be placed in such appliances, advantageously at a certain height within the vessel, in order to cook food.

The present invention also relates to methods of manufacturing food-cooking baskets for pressure cookers, when said baskets are made out of sheets of metal and are obtained by stamping.

The present invention relates to a food-cooking basket for pressure cooking in a pressure cooker, said basket being formed by a sheet of rigid material defining a bottom and side walls for the basket, said sheet being provided with perforations for allowing steam in the enclosure of the pressure cooker to pass through the perforations and through the food, in particular vegetables contained in the basket.

The present invention also relates to a pressure cooker for receiving a cooking basket and comprising a vessel and a cover, said vessel including means for supporting the basket in the vessel, said supports being arranged in or on walls for holding the cooking basket in a predetermined position at a distance from the bottom of the vessel, in order to perform a steam cooking cycle.

The present invention also relates to a method of manufacturing a food-cooking basket for a pressure cooker by stamping a sheet of metal.

### PRIOR ART

In order to enable the user of a pressure cooker to cook other than by immersing the food in the liquid contained in the cooking vessel, it is necessary to make provision for a cooking basket containing the food to be integrated in the vessel together with means for supporting the cooking basket arranged in or on the walls and at a certain predetermined height in such a manner as to enable the basket to be supported at a predetermined height above the cooking liquid. It is also necessary to provide a certain number of perforations in the basket so as to enable steam to circulate not only within the enclosure of the pressure cooker, but also through the food, thereby optimizing heat exchange.

Such systems are well known and make use of baskets, generally metal baskets, having a variety of shapes and capacities, the basket support means being constituted by a removable support, e.g. made of steel wire placed on the bottom of the vessel when the user desires to perform steam cooking. There also exist support means formed by pieces fitted to the wall of the vessel (rivets) or formed by localized deformations in the wall of the vessel, these deformations supporting the basket at a predetermined height above the bottom of the vessel.

Presently-known metal baskets can be categorized in two main types.

The first type is constituted by “net” baskets obtained using interlaced or meshed steel wires and provided with a stiffening structure giving them a degree of mechanical strength. Such baskets generally give satisfaction, but they suffer from drawbacks associated with the difficulty of containing food because of their large mesh size and associated with being very difficult to clean, specifically because of the mesh which makes it difficult in particular to be sure of removing food waste. In addition, the lifetime of such baskets is short because they are relatively fragile.

The second known type of basket is formed by metal baskets obtained by stamping and including a series of perforations formed either through the bottom of the basket, or through both the bottom and the side walls. Such baskets generally give satisfaction and are acceptably easy to clean. However, their ability to ensure good heat exchange with the food is greatly variable and difficult to control.

It is also known that a balanced diet requires a regular intake of vitamins, in particular vitamin C, from fruit and vegetables which constitute the main sources. Studies undertaken on this topic have shown not only that the consumption of fruit and vegetables in the general population has been insufficient over the last few years, but further that the general trend is towards a relative drop of such consumption. One of the factors that might explain this low level of consumption and this general trend is that the potential consumer comes up against a series of constraints in use that tend to limit the consumption of fruit and vegetables, and in particular: the need to obtain provisions frequently, the need to clean them or peel them, and finally the need to perform a cooking operation on vegetables, it being understood that this constraint, which is perceived negatively, is a constraint concerning the time needed for cooking.

In general, there therefore exists a need to improve general dietary conditions, or at least to prevent them from deteriorating, and that has led to a search for solutions that enable the time required for cooking food, and in particular vegetables, to be reduced.

It is also known that vitamins are very sensitive to cooking conditions and can be completely or partially destroyed, leached out, or degraded during cooking. Amongst vitamins in general, vitamin C is the most fragile, even though fruit and vegetables contribute about 85% of dietary intake of vitamin C. It is thus extremely important to maintain a quantity of vitamin C in vegetables after they have been cooked, in particular after they have been pressure cooked.

Amongst the known phenomena concerning the fragility in cooking of the vitamin C contained in vegetables, mention can be made that vitamin C is soluble in water when it is in the form of folates, which makes it sensitive to being leached out by the cooking water. Furthermore, vitamin C is sensitive to temperature and is destroyed in proportion to the time and the temperature applied during cooking.

Finally, vitamin C is sensitive to oxidation and thus degrades correspondingly with increasing contact with air.

There thus also exists a general problem of preserving vitamins, and in particular vitamin C, while cooking vegetables in pressurized cooking appliances such as pressure cookers.

### SUMMARY OF THE INVENTION

The object given to the invention seeks consequently to provide a novel food-cooking basket for use in pressure cooking in a pressure cooker, which basket makes it possible to reduce the time required to cook food while preserving the vitamins present in the food, and in particular in vegetables.

Another object of the invention is to propose a novel food-cooking basket which enables the circulation of steam in the enclosure of the pressure cooker to be optimized while enabling such a basket to be made easily in industrial manner.

Another object of the invention seeks to provide a novel food-cooking basket that is easily cleaned.

Another object of the invention is to propose a novel cooking basket which does not interfere with the operation of the safety members of a pressure cooker in which the basket is mounted.

Another object of the invention seeks to provide a novel food-cooking basket which is particularly robust and easy to manufacture, while also being easy to handle and suitable for positioning at will.

Another object of the invention seeks to propose a novel cooking basket which is made easy to handle without running the risk of scalding.

Another object of the invention also seeks to propose a novel pressure cooker making it possible to cook different kinds of food in different manners under pressure without disturbing the general and safety operation of the pressure cooker.

Another object of the invention seeks to propose a novel method of manufacturing a food-cooking basket by stamping, making it possible to obtain a cooking basket in simple and repetitive manner.

Another object of the invention seeks to propose a novel method of manufacture that is particularly simple and effective to implement.

The objects given to the invention are achieved by means of a food-cooking basket for pressure cooking in a pressure cooker, the basket being made of a sheet of rigid material defining a bottom and side walls of the basket, said sheet being provided with perforations, the basket being characterized in that the perforations are provided at least through the side walls and represent at least 30% of the total area of the sheet.

The objects given to the invention are also achieved by means of a pressure cooker for receiving a cooking basket of the invention and comprising a vessel and a cover, said vessel having support means for supporting the basket in the vessel arranged in or on the walls, the pressure cooker being characterized in that the vessel has a least two rows of support means disposed at different heights so as to enable at least two cooking baskets to be disposed in superposed manner inside the vessel.

The objects of the invention are also achieved by means of a method of manufacturing a food-cooking basket for a pressure cooker by stamping a sheet of metal, the method being characterized by the following successive steps:
a) perforating the sheet of metal;
b) cutting the sheet to obtain a blank having the final shape of the basket;
c) stamping the blank in its central portion; and
d) trimming the edge to obtain the basket.

### BRIEF DESCRIPTION OF THE DRAWINGS

Other objects and advantages of the invention are explained in greater detail on reading the following description and from the accompanying drawings given by way of non-limiting illustrative examples, in which:

FIG. 1 is a perspective view of a cooking basket in accordance with the invention;

FIG. 2 is a plan view of a cooking basket in accordance with the invention and identical with the basket shown in FIG. 1;

FIG. 3 is a cross-section view showing a detail of the structure of a cooking basket in accordance with the invention;

FIG. 4 is a cross-section view showing a cooking basket in a high position inside a pressure cooker;

FIG. 4A is a cross-section view showing a pressure cooker in accordance with the invention containing two cooking baskets in accordance with the invention in a superposed configuration;

FIG. 5 shows the various successive stamping steps that lead to the manufacture of a cooking basket in accordance with the invention;

FIG. 6 shows the uniformity of temperature rise in food within a cooking basket of the invention; and

FIG. 7 is a graph on a basis comparable to that of FIG. 6 and showing the non-uniformity of the temperature rise of food contained in a prior art cooking basket.

### BEST METHOD OF IMPLEMENTING THE INVENTION

The food-cooking basket of the invention is designed to be used and placed in a food-cooking appliance of the pressure cooker type, regardless of whether the pressure cooker is of the clamp, jaw, bayonet, or manhole type, without this list being considered to be limiting.

In the description below, the cooking basket of the invention is advantageously made in the form of a circular basket, without that shape being limiting, it being possible for cooking baskets in accordance with the invention to be of a shape other than circular, and for example rectangular, square, etc., without thereby going beyond the ambit of the invention.

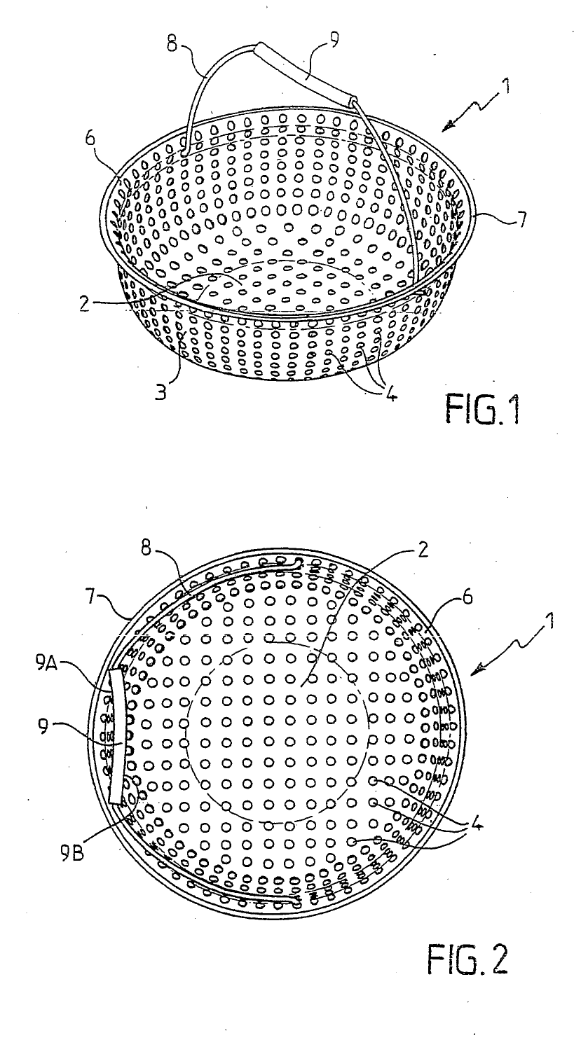

The food-cooking basket 1 shown in FIGS. 1 to 5 is for use in pressure cooking in a pressure cooker and it is constituted by a sheet of rigid material defining a bottom 2 and side walls 3 of the basket 1, said sheet being provided with perforations 4.

In the meaning of the invention, the rigid material may be based on any material capable, durably and continuously, of withstanding being used in a pressure cooker where it comes into contact with food, of being subjected to successive and repeated cleaning operations, and of being subjected to operations of raising its temperature and pressure.

Advantageously, the rigid sheet material is made of metal, and advantageously of stainless steel, it nevertheless being understood that other types of material, and in particular plastics materials could be envisaged, without thereby going beyond the general ambit of the invention.

According to an important characteristic of the invention, the perforations 4 are arranged, at least through the side walls 3, so as to represent at least 30% of the total area of the sheet constituting the basket and forming its total area.

It has been found that below this percentage representing the ratio between the surface area of the sheet forming the container proper and the perforations 4, it becomes difficult to make the basket industrially, and above all the effects relating to reducing cooking time and retaining vitamins in the food contained in the basket 1 are not good or beneficial.

Advantageously, the perforations 4 in the side walls 3 are made and distributed in substantially regular manner starting from the bottoms of the side walls 3 adjacent to the bottom 2, and occupying substantially the entire circumference of the side walls up to a determined height.

It has been found that the vitamin-retaining effect and the reduction in cooking time are more significant when the perforations 4 are situated in the lower portion of the basket 1 up to a determined height corresponding substantially to the depth of the food present in the cooking basket 1.

Preferably, the perforations 4 represent at least 35% of the total area of the sheet, and preferably they represent 35% to 58%.

In a particularly advantageous manner, and as shown in FIGS. 1 to 5, the perforations 4 are distributed substantially uniformly over and through the bottom 2 and the side walls 3. It has been found that best results are obtained with a basket having perforations 4 in its bottom 2 and over a significant height of its side walls 3.

As shown in FIGS. 1 to 5, and in a preferred variant, the perforations 4 in the side walls 3 are made all the way up to the top edge 6 of said side walls 3 so as to obtain a cooking basket whose entire surface area is regularly perforated.

As shown in the figures, the perforations 4 are advantageously substantially circular, having a diameter of not less than 3 millimeters (mm), and preferably lying in the range 3 mm to 5 mm. Nevertheless, the perforations 4 could be of other shapes and of greater size, without thereby going beyond the ambit of the invention.

When the perforations 4 are circular, they are disposed at regular distances apart, for example at a regular pitch of 5 mm to 8 mm, with the thickness of the sheet of rigid material lying, for example, in the range 0.4 mm to 0.8 mm, and preferably being about 0.5 mm or about 0.4 mm.

As shown in the figures, the perforations 4 may be disposed in regular lines or in preferential arrangements referred to as T-, U-, M-, or Z-configurations depending on the geometrical disposition of the perforations relative to one another.

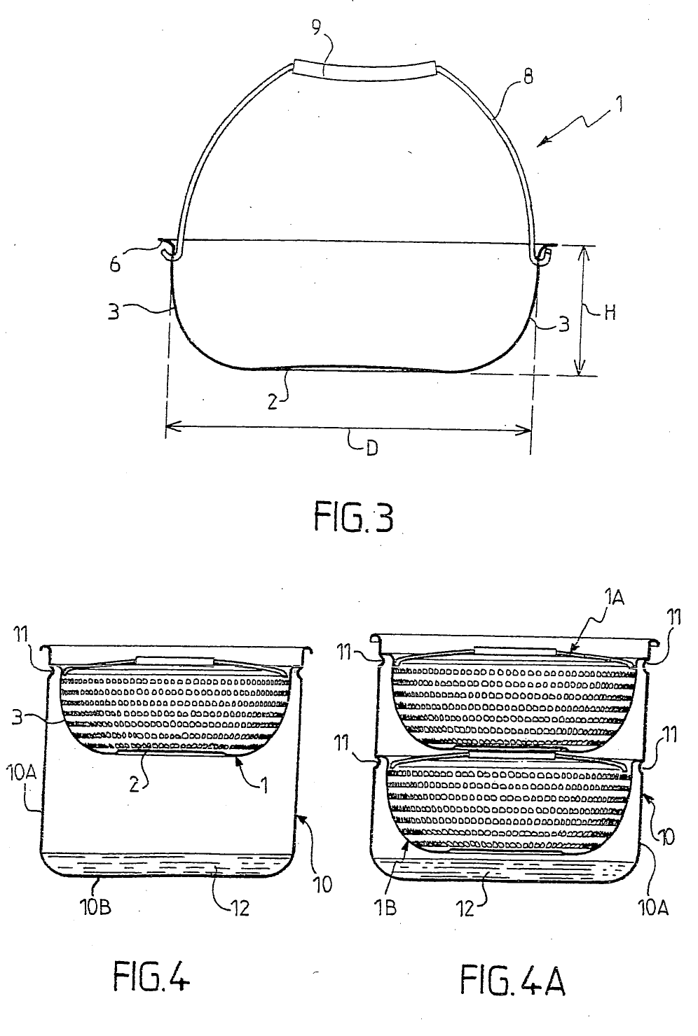

As shown in FIG. 3, the junction between the bottom 2 and the side walls 3 is advantageously made in such a manner as to present curvature that is regular, for example having a radius of curvature R that is greater than or equal to H/2, where H is the height of the basket 1 (cf. FIG. 3). It has been found that maintaining a radius of curvature helps reduce internal disturbances due to the cooking steam which might otherwise tend to impede proper lifting of the safety devices of the pressure cooker, and in particular of the safety and locking valve(s).

Advantageously, the basket 1 of the invention is of circular section having a diameter D and a height H which is substantially equal to ⅓ D.

As shown in FIGS. 1 to 5, the side walls 3 are terminated at their top end by a curved edge 6 extending radially outwards from the basket in question and its axis of symmetry, over a width that is constant around the entire periphery. This feature enables the cooking appliance to be positioned in the vessel of the pressure cooker without any particular angular indexing. In addition, the presence of a continuous curved edge 6 that fits the inside wall of the pressure cooker vessel (ignoring the clearance needed to enable the basket to be inserted) constrains the steam to pass through the basket, and thus through the food, thereby optimizing heat transfer.

The curved edge 6 is advantageously provided with a peripheral ring 7, e.g. made of metal, fitted on and folded round said edge so as to reinforce the rigidity of the basket and improve its finish.

As shown in FIGS. 1 to 3, the basket of the invention has a handle 8 mounted to pivot between a basket-supporting position as shown in FIG. 1 and at least one rest position as shown in FIG. 2 where it rests on the top edge 6 of the basket, substantially lying on the periphery of the edge. In this configuration, the handle 8 is substantially semicircular in shape.

Advantageously, and in accordance with the invention, the handle 8 includes a grip portion 9 substantially in its center, the grip portion being based on silicone and being set back inside from the remainder of the handle so that it does not rest on said edge 6.

In the preferred variant shown in FIG. 2, the grip portion 9 is curved and forms a regular curved portion defining a concave portion 9A facing towards the outside of the basket and a convex portion 9B facing towards the inside of the basket. This feature makes it much easier to take hold of the handle without burning the fingers.

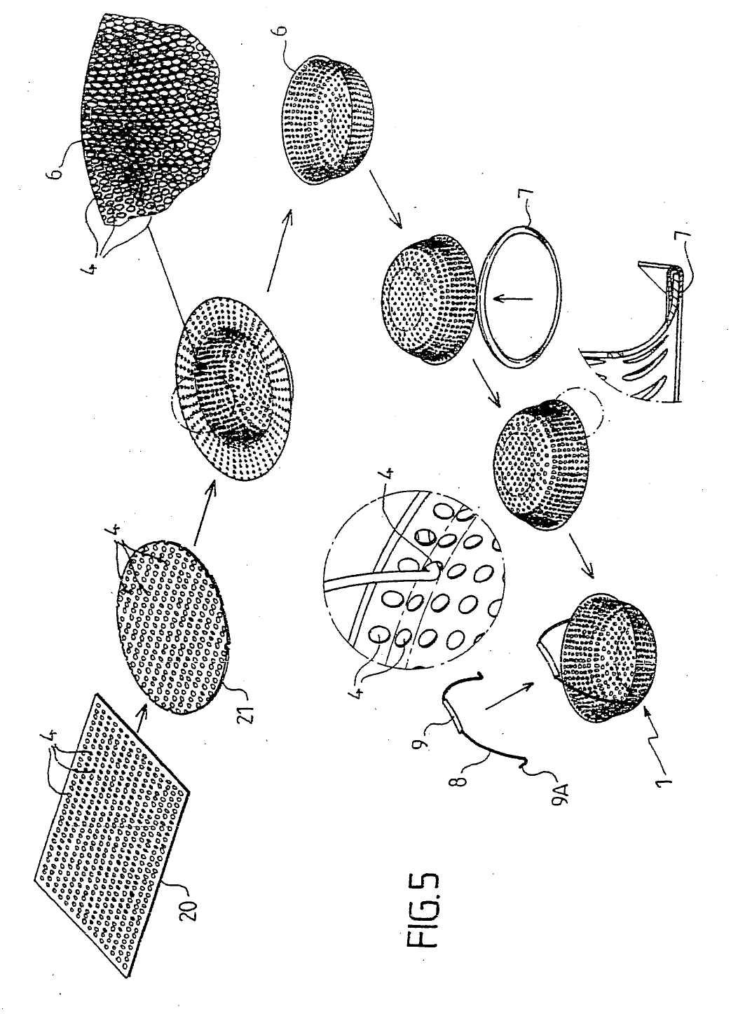

As shown in FIGS. 4 and 4A, the cooking basket 1 is for placing in a vessel 10 of a pressure cooker provided with a cover (not shown in the figures) so as to perform pressure cooking.

The pressure cooker of the invention comprises a vessel 10 having support means 11 for supporting the basket 1 in the vessel, said support means 11 being formed radially in or from the walls 10A of the vessel. These support means 11 are well known to the person skilled in the art and may be constituted by indentations (or similar means) obtained by pressing or deforming the wall, as described in patent FR-2 783 685 in the name of the Applicant, for example. In this configuration, the cooking basket 1 of the invention is placed in the vessel 10 so that its rim 6 rests against the support means 11 that are angularly distributed at the same height on the side walls 3.

As shown in FIG. 4, the support means 11 are at a sufficient predetermined height from the bottom 10B of the vessel 10 for the basket 1 to remain at a distance from said bottom 10B and from any liquid 12 contained in the vessel 10.

According to an important characteristic of the invention, the pressure cooker of the invention comprises a vessel 10 having at least two rows of support means 11 disposed at different reference heights so as to enable at least two cooking baskets to be disposed in a superposed configuration inside the vessel, as shown in FIG. 4A. By means of this disposition, it is possible to place a first basket 1A in an upper position, and a second basket 1B in a lower position, neither of the baskets being immersed in the supply of liquid 12, thereby enabling food to be steam-cooked, without the food in the baskets being mixed as is the case in the prior art using a single basket.

Furthermore, the circulation of steam within the pressure cooker enclosure is controlled by controlling the density of the perforations, thus enabling different cooking to be performed without disturbing the lifting of the valve locking devices.

In particularly advantageous manner, the method of manufacturing a food-cooking basket for a pressure cooker in accordance with the invention is performed by stamping a sheet of metal, e.g. a sheet of stainless steel, as shown in FIG. 5.

As shown in FIG. 5, the method comprises the following successive steps:
a) perforating the sheet of metal 20;
b) cutting the sheet 20 so as to obtain a blank 21 in the final shape of the basket, e.g. circular;
c) stamping the central portion of the blank 21; and
d) trimming the edge to obtain the basket 1.

Naturally it is also possible to start the method using a sheet of metal that has already been perforated, without thereby going beyond the ambit of the invention.

More precisely, the metal sheet 20 may advantageously be perforated over its entire area, for example by means of a series of perforations 4 in continuous lines or in any other configuration, providing the sheet 20 is perforated in such a manner that the perforations 4 represent at least 30% of the total area of the sheet.

Stamping proper is performed in a manner known to the person skilled in the art, with the bottom limit on making the basket by stamping being associated with the concentration of perforations 4 representing at least 30% of the total area of the sheet.

As shown in FIG. 5, the deformation of the perforations 4 during the primary stamping operation, and in particular the differential stretching of the top perforations 4 makes it possible to ensure that the sheet deforms properly, thereby guaranteeing that stamping is successful.

The sheet 20 is preferably perforated in such a manner that the perforations represent at least 35% and preferably 35% to 58% of the total area of the sheet.

As shown, the sheet is perforated over its entire area. During the operation prior to stamping, the sheets are perforated in such a manner as to obtain perforations that are circular, of mean diameter lying in the range 3 mm to 5 mm and at a pitch lying in the range 5 mm to 8 mm, with the blank subsequently being cut out circularly.

At the end of the initial stamping stage, the edge is trimmed so as to obtain a top peripheral edge 6 for the basket that is substantially outwardly curved and of small radial extent.

Thereafter, a circular peripheral ring 7 is placed on the curved peripheral edge 6 and crimped thereto.

Advantageously, stamping is formed in such a manner that the junction is between the bottom 2 and the side walls 3 of the basket presents curvature that is regular.

Thereafter, the handle 8 is put into place, with the ends 9A of said handle being inserted into perforations 4.

Table 1 below compares the results of vitamin C preservation obtained during steam cooking for various vegetables, both when cooking in a conventional prior art basket (without purging) and in a basket of the invention with a purge system on the pressure cooker. By way of example, it is estimated that for green beans, the purge system reduces cooking time by about 35% to 41% and improves vitamin C preservation by about 23% to 25%.

TABLE 1
VITAMIN C PRESERVATION IN STEAM COOKING

| | | | | | Fresh | Frozen | | |
|---|---|---|---|---|---|---|---|---|
| | | Fresh | Frozen | | cauli- | cauli- | Courgettes | Green |
| | Spinach | broccoli | broccoli | Carrots | flower | flower | (zucchini) | beans |
| Vitamin C | 22.3 | 137.5 | 52.7 | 28.5 | 54.0 | 35.0 | 24.8 | 3.0 |
| content in | | | | | | | | |
| raw vegetables | | | | | | | | |
| in mg/100 g | | | | | | | | |
| Time | | | | | | | | |
| Prior art basket | 10′ | 9′30 | 8′50 | 10′30 | 11′ | 11′30 | 9′30 | 12′ |
| Basket | 4′ | 2′30 | 1′30 | 4′30 | 2′30 | 2′ | 2′ | 4′30 |
| of the | | | | | | | | |
| invention | | | | | | | | |
| Saving (%) | −60% | −74% | −83% | −57% | −77% | −83% | −79% | −62% |
| Vitamin C | | | | | | | | |
| preservation (%) | | | | | | | | |
| Prior art basket | 53% | 34% | 85% | 61% | 78% | 62% | 37% | 24% |
| Basket of the | 67% | 40% | 97% | 72% | 91% | 78% | 52% | 39% |
| invention | | | | | | | | |
| Saving (%) | +26% | +18% | +14% | +18% | +17% | +27% | +42% | +62% |

The prior art basket was constituted by a perforated metal basket having orifices of about 3 mm, said orifices being provided through the bottom of the basket and occupying considerably less than 20% of the total surface area of the basket. The basket of the invention was of a form similar to the basket shown in FIGS. 1 to 5 and it had a series of orifices 4 of diameter approximately 5 mm regularly distributed over the entire surface of the basket up to the top edge 6, and representing 30% of the area of the basket.

The results show clearly that the saving in cooking time that is obtained with the vegetables in question enables cooking time to be reduced by about 57% to 83%.

Similarly, vitamin C preservation in the vegetables in question was considerably increased, since more vitamin C was observed to be retained, in an amount that varied depending on the vegetables, but which enabled an improvement in vitamin retention to be obtained lying in the range 14% to 62%.

These improved results should be compared with the specific configuration of a basket of the invention in which the size, distribution, and density of perforations 4 serves to enable optimum movement of the steam of steam, thereby encouraging excellent heat exchange throughout the mass of vegetables, thus enabling cooking to take place quickly and uniformly, which is necessary in order to obtain better vitamin retention.

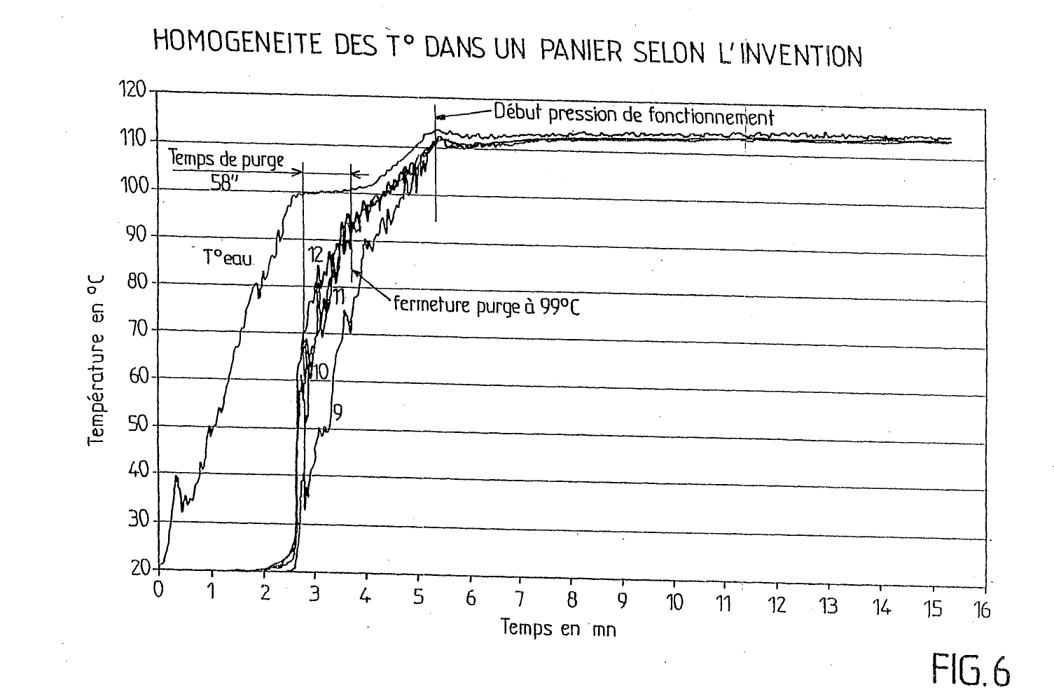

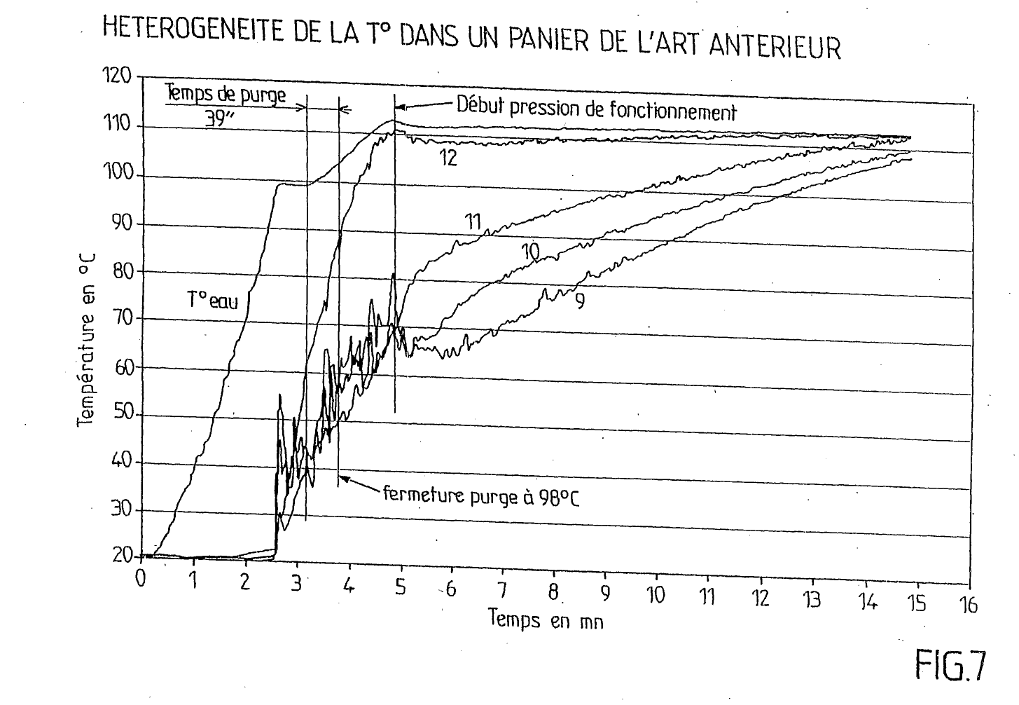

The advantageous phenomena involved can be explained by comparing the graphs shown in FIGS. 6 and 7 which show the differences in the uniformity of food temperature rise, in this case potatoes, in a basket of the invention (FIG. 6) and in a prior art basket (FIG. 7).

The two baskets had technical characteristics identical to the two above-defined baskets.

Temperature levels were measured by means of four probes distributed in the central portion of the basket at different depths within the food, and from the graphs, it can be seen that in a basket of the invention temperature rise for all of the probes was particularly uniform and fast over the time interval t₁=2 min 30 sec to t₂=5 min 30 sec, measured from the start of cooking. The final cooking temperature was obtained as from 5 min 30 sec of cooking, approximately, and it was thoroughly equal and uniform within the food, regardless of position within the basket, since the temperature measured by all four probes was identical and equal to about 110° C.

In contrast, in a prior art basket, the cooking temperature of the food was particularly non-uniform, the four temperature curves for all four probes becoming substantially equal (and even then not completely) after cooking for about 15 minutes.

During the testing, the mean cooking pressure was about 1.5 bar, each pressure cooker being fitted with a purge system enabling steam to be exhausted from the enclosure of the pressure cooker during the rise in pressure.

These graphs also show that the speed of the rise in temperature in a basket of the invention, given that once the mean operating pressure was reached at about 110° C., the entire mass of food was at the mean operating temperature of about 110° C. Conversely, in a prior art basket, the mean temperature of 110° C. was obtained only after about 14 min to 15 min of operation.

These results thus show that a cooking basket of the invention is effective in terms of reducing cooking time and in terms of preserving vitamins. The basket also presents the advantage of avoiding localized zones being created in which air is retained, because of its optimized and uniformly distributed perforations. Nevertheless, it is important to observe that the saving in time and the improvement in vitamin retention is highly variable from one vegetable to another, the cooking time being divided by 2.5 to 5.5, and the loss of vitamin C during cooking being reduced by about 1.3 times to about 5 times.

Susceptibility of Industrial Application

The invention is susceptible of industrial application in the design and manufacture of domestic cooking appliances of the pressure cooker type, and also of cooking baskets for use in association with said appliances.

1-22. (canceled)

23. A food-cooking basket for pressure cooking in a pressure cooker, the basket comprising a sheet of rigid material defining a bottom and side walls of the basket, said sheet being provided with perforations, wherein the perforations are provided at least through the side walls and represent at least 30% of the total area of the sheet.

24. The basket according to claim 23, wherein the perforations of the side walls are made substantially regularly starting from the bottoms of the side walls, and over substantially the entire circumference thereof up to a determined height.

25. The basket according to claim 23, wherein the perforations represent between 35% and 58% of the total area of the sheet.

26. The basket according to claim 23, wherein the perforations are distributed substantially regularly over and through the bottom and the side walls.

27. The basket according to claim 26, wherein the perforations in the side walls are made all the way to the top edge of said side walls.

28. The basket according to claim 23, wherein the perforations are substantially circular and have a diameter in the range from 3 mm to 5 mm.

29. The basket according to claim 23, wherein a junction between the bottom and the side walls presents regular curvature.

30. The basket according to claim 23, wherein the basket is circular in section with a diameter D and a height H=⅓ D.

31. The basket according to claim 23, wherein the side walls terminate at their top end in a curved edge extending radially outwards over a width that is constant around the periphery.

32. The basket according to claim 31, wherein the curved edge is provided with a peripheral ring fitted to and folded over said edge.

33. The basket according to claim 23, further comprising a handle pivotally mounted between a support position and at least one rest position in which it rests on the top edge of the basket substantially following the periphery of the edge, wherein the handle includes a grip portion forming an inwardly directed setback from the remainder of the handle which does not rest on said edge.

34. A pressure cooker fitted with the basket according to claim 23.

35. A pressure cooker for receiving the basket according to claim 23 and comprising a vessel and a cover, said vessel having support means for supporting the basket in the vessel arranged in or on the walls, the vessel having at least two rows of support means disposed at different heights so as to enable at least two cooking baskets to be disposed in a superposed manner inside the vessel.

36. A method of manufacturing a food-cooking basket for a pressure cooker by stamping a sheet of metal, the method comprising:
perforating the sheet of metal or providing a previously-perforated sheet;
cutting the sheet to obtain a blank having the final shape of the basket;
stamping the blank in its central portion; and
trimming the edge to obtain the basket.

37. The method according to claim 36, wherein the sheet is perforated in such a manner that the perforations represent at least 30% of the total area of the sheet.

38. The method according to claim 37, wherein the sheet is perforated in such a manner that the perforations represent from 35% to 58% of the total area of the sheet.

39. The method according to claim 36, wherein the sheet is perforated over its entire area.

40. The method according to claim 36, wherein the sheet is perforated in order to obtain circular perforations having a mean diameter lying in the range from 3 mm to 5 mm and at a pitch lying in the range from 5 mm to 8 mm.

41. The method according to claim 36, wherein the blank is cut out to be circular.

42. The method according to claim 36, wherein the edge is trimmed so as to obtain a top peripheral edge of the basket that is curved substantially outwards.

43. The method according to claim 42, wherein a circular peripheral ring is put into position on the curved peripheral edge and is crimped onto said edge.

44. The method according to claim 36, wherein the stamping is performed in such a manner that the junction between the bottom and the side walls of the basket presents regular curvature.
